(19) United States
(12) Patent Application Publication
(10) Pub. No.: US 2023/0044836 A1
(43) Pub. Date: Feb. 9, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shinji NOZAKI, Mie (JP)

(21) Appl. No.: 17/790,894

(22) PCT Filed: Dec. 25, 2020
(86) PCT No.: PCT/JP2020/048630

§ 371 Date: Jul. 5, 2022

(30) Foreign Application Priority Data
Jan. 15, 2020 (JP) 2020-004206

(51) Int. Cl. H01R 13/627

(52) U.S. Cl. CPC H01R 13/6273; H01R 2201/26

(57) ABSTRACT

It is aimed to make only some of a plurality of housings in a connected state separable. A connector is provided with a first housing and a second housing connectable to the first housing. The second housing includes a detachable housing connectable to the first housing and separable from the first housing and an inseparable housing connectable to the first housing. The first housing and the inseparable housing are provided with an unreleasable lock portion and a lock arm for locking the inseparable housing and the first housing in a connected state. The unreleasable lock portion and the lock arm have no part enabling release of locking by the unreleasable lock portion and the lock arm.

### TECHNICAL FIELD

The present disclosure relates to a connector.

### BACKGROUND

Patent Document 1 discloses a connector structure in which a female connector housing of a female connector is fit into a male connector housing of a male connector and the male and female connectors are locked in a connected state by locking a lock arm portion formed on the female connector housing to a lock receiving portion of the male connector housing. In this connector structure, the locking of the lock arm portion and the lock receiving portion can be released and the both connectors can be separated by operating an operating portion of the lock arm portion.

### PRIOR ART DOCUMENT

### Patent Document

Patent Document 1: JP 2014-011092 A

### SUMMARY OF THE INVENTION

### Problems to be Solved

In the case of a connector structure including a critical circuit necessary for safe driving of an automotive vehicle and other normal circuits, it is desired to keep the critical circuit in a closed state while the normal circuits are opened for maintenance or the like. In this case, for example, a female connector may be divided into two sub-connectors for the critical circuit and the normal circuits and the two sub-connectors may be connected to one male connector. However, if the male connector and the both sub-connectors are kept in a connected state by providing lock arm portions on the sub-connectors, the lock arm portion of the sub-connector for the critical circuit may be erroneously unlocked.

A connector of the present disclosure was completed on the basis of the above situation and aims to make only some of a plurality of housings in a connected state separable.

### Means to Solve the Problem

The present disclosure is directed to a connector with a first housing and a second housing connectable to the first housing, wherein the second housing includes a detachable housing connectable to the first housing and separable from the first housing and an inseparable housing connectable to the first housing, the first housing and the inseparable housing are provided with connecting lock portions for locking the inseparable housing and the first housing in a connected state, and the connecting lock portions have no part enabling release of locking by the connecting lock portions.

### Effect of the Invention

According to the present disclosure, it is possible to make only some of a plurality of housings in a connected state separable.

### BRIEF DESCRIPTION OF THE DRAWINGS

FIG. 1 is a perspective view showing a state where an inseparable housing is connected to a first housing.

FIG. 2 is a perspective view of the first housing.

FIG. 3 is a perspective view of a detachable housing viewed from front.

FIG. 4 is a perspective view of the inseparable housing viewed from behind.

FIG. 5 is a front view showing a state where the detachable housing is connected to the inseparable housing.

FIG. 6 is a section along X-X of FIG. 5 showing a process of uniting the detachable housing and the inseparable housing.

FIG. 7 is a section along X-X of FIG. 5 showing a state where the detachable housing is united with the inseparable housing.

FIG. 8 is a front view in section showing a state where the first housing and a second housing are connected.

FIG. 9 is a section along Y-Y of FIG. 8 showing a state where the first and second housings are connected.

FIG. 10 is a section along Z-Z of FIG. 8 showing a process of connecting the first and second housings.

FIG. 11 is a section along Z-Z of FIG. 8 showing the state where the first and second housings are connected.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing and a second housing connectable to the first housing, wherein the second housing includes a detachable housing connectable to the first housing and separable from the first housing and an inseparable housing connectable to the first housing, the first housing and the inseparable housing are provided with connecting lock portions for locking the inseparable housing and the first housing in a connected state, and the connecting lock portions have no part enabling release of locking by the connecting lock portions. According to the configuration of the present disclosure, with the first housing and the second housing connected, the inseparable housing remains locked in the state connected to the first housing when the detachable housing is separated from the first housing. According to the connector of the present disclosure, out of the detachable housing and the inseparable housing in the connected state, only the detachable housing can be separated from the first housing.

(2) Preferably, the detachable housing and the inseparable housing include uniting locking portions, and the detachable housing and the inseparable housing are held in a united state by locking the uniting locking portions to each other in a state not connected to the first housing yet. According to this configuration, an operation of connecting the second housing to the first housing can be performed by one action.

(3) Preferably, in (2), the uniting locking portion of the inseparable housing is a projection-like lock receiving portion, the uniting locking portion of the detachable housing is a resilient locking piece resiliently displaceable in a first deflecting direction intersecting an assembling direction of the detachable housing with the inseparable housing, the resilient locking piece is resiliently displaced in the first deflecting direction by interfering with the lock receiving portion in the process of assembling the detachable housing with the inseparable housing, and the resiliently restored resilient locking piece is locked to the lock receiving portion with the detachable housing assembled with the inseparable housing. According to this configuration, workability is good since a separate manual operation of displacing the resilient locking piece is unnecessary in assembling the detachable housing with the inseparable housing.

(4) Preferably, in (3), the first housing includes a deflection restricting portion, and the resilient locking piece is restricted from being resiliently displaced in the first deflecting direction by the deflection restricting portion with the detachable housing connected to the first housing. According to this configuration, even if the first and second housings in the connected state vibrate, the resilient locking piece and the lock receiving portion can be kept in a locked state.

(5) Preferably, in (3) or (4), the first housing includes a separation interfering portion, and the resilient locking piece is disengaged from the lock receiving portion by interfering with the separation interfering portion in the process of separating the detachable housing from the first housing. According to this configuration, workability is good since a separate manual operation of disengaging the resilient locking piece from the lock receiving portion is unnecessary in separating the detachable housing from the first housing.

(6) Preferably, in (5), the first housing includes a deflection restricting portion, the resilient locking piece is restricted from being resiliently displaced in the first deflecting direction by the deflection restricting portion with the detachable housing connected to the first housing, the resilient locking piece is resiliently displaceable in a second deflecting direction intersecting both the assembling direction of the detachable housing with the inseparable housing and the first deflecting direction, and the resilient locking piece is resiliently displaced in the second deflecting direction when interfering with the separation interfering portion. According to this configuration, the resilient locking piece can be disengaged from the lock receiving portion by being resiliently displaced in the second deflecting direction even if a resilient displacement of the resilient locking piece in the first deflecting direction is restricted.

### Details of Embodiment of Present Disclosure

### Embodiment

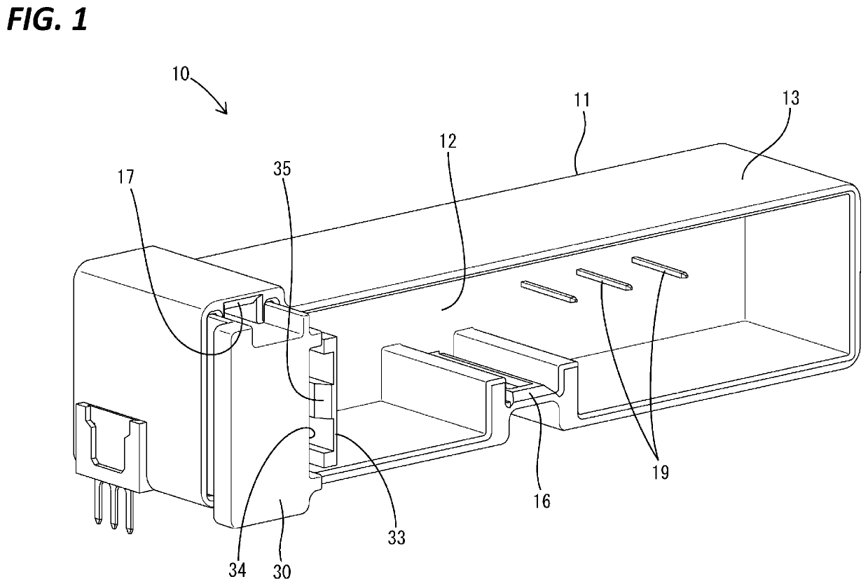

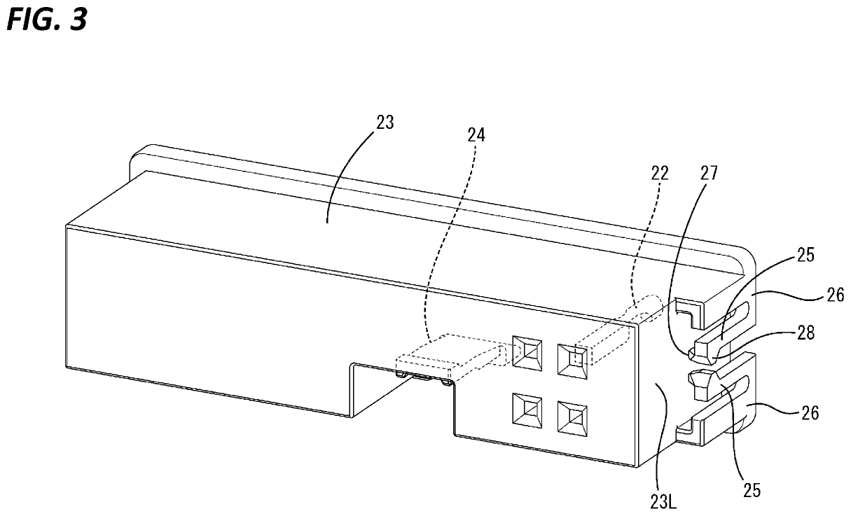

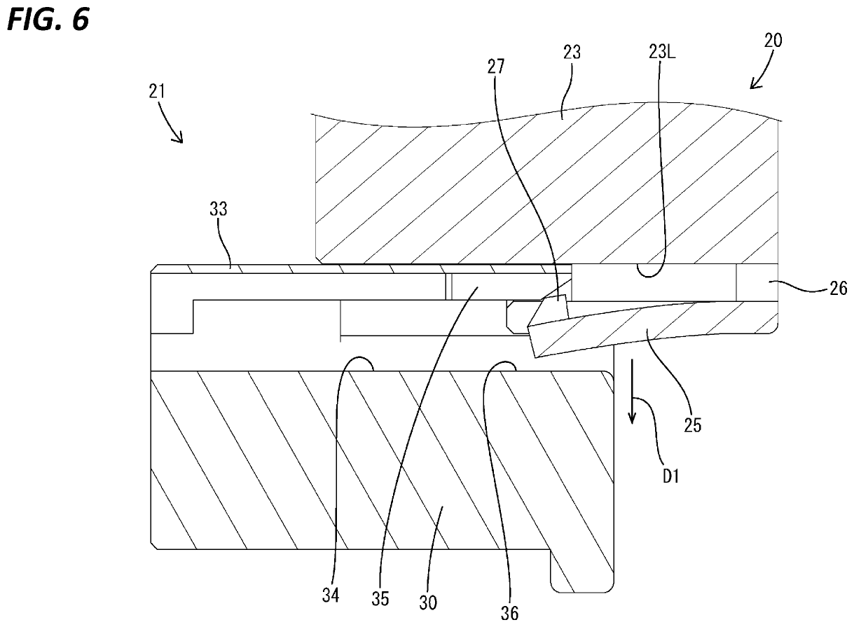

One specific embodiment of a connector of the present disclosure is described with reference to FIGS. 1 to 11. Note that the present invention is not limited to these illustrations and is intended to be represented by claims and include all changes in the scope of claims and in the meaning and scope of equivalents. In this embodiment, a left side in FIGS. 6, 7 and 9 to 11 is defined as a front side concerning a front-rear direction. Upper and lower sides shown in FIGS. 1 to 5 and 8 to 11 are directly defined as upper and lower sides concerning a vertical direction. Left and right sides shown in FIGS. 1, 2 and 4 are directly defined as left and right sides concerning a lateral direction. Contents shown in FIGS. 3, 5 and 8 are laterally reversed.

The connector of this embodiment includes a first connector 10 and a second connector 20. The first and second connectors 10, 20 are connected by being relatively displaced in the front-rear direction, and separated by being relatively displaced in the front-rear direction. The connector of this embodiment is for connecting a wiring harness (not shown) installed in an automotive vehicle and a circuit board of a circuit for controlling driving safety equipment.

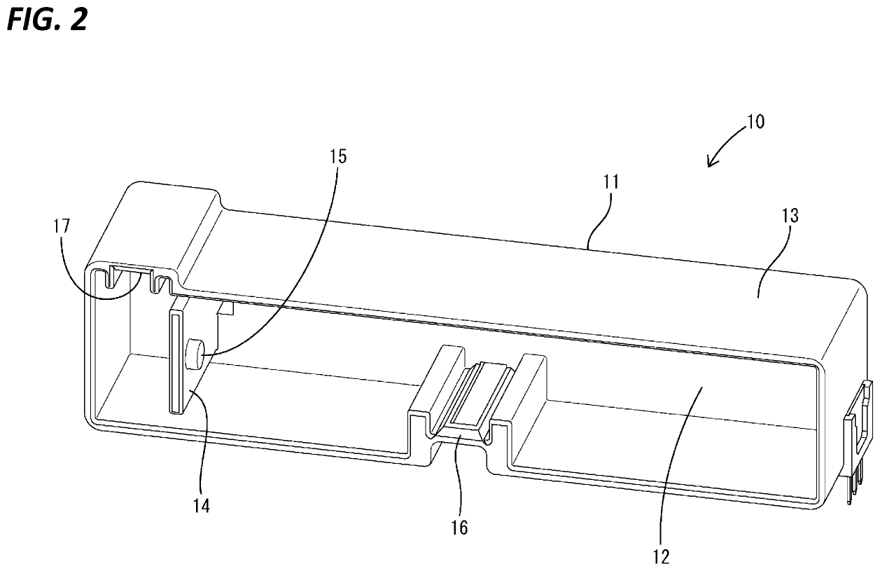

The first connector 10 includes a first housing 11 made of synthetic resin and a plurality of first terminal fittings 19 mounted in the first housing 11. The first connector 10 is used as a board connector to be mounted on a circuit board (not shown). As shown in FIGS. 1 and 2, the first housing 11 has a shape elongated in the lateral direction as a whole and includes a wall-like terminal holding portion 12 for holding the first terminal fittings 19 and a receptacle 13 in the form of a rectangular tube projecting rearward from the terminal holding portion 12.

A deflection restricting portion 14 projecting rearward into the receptacle 13 from the back end surface of the terminal holding portion 12 is formed in a left end part of the first housing 11. The deflection restricting portion 14 is in the form of a plate having a plate thickness direction oriented in the lateral direction. Gaps are formed between both upper and lower end parts of the deflection restricting portion 14 and the inner surface of the receptacle 13. A separation interfering portion 15 is formed on the right side surface of the deflection restricting portion 14. The separation interfering portion 15 has a cylindrical shape having an axis oriented in the lateral direction.

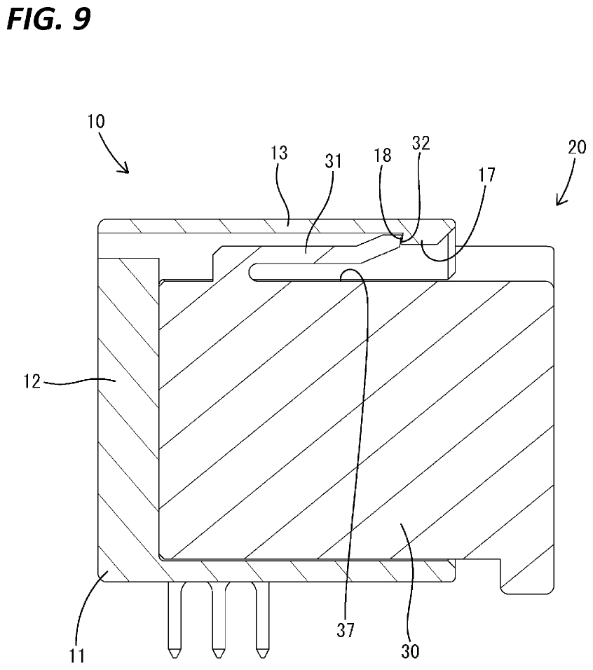

A releasable lock portion 16 is formed in a lower wall portion constituting the receptacle 13. The releasable lock portion 16 is arranged to the right of the deflection restricting portion 14. As shown in FIG. 9, an unreleasable lock portion 17 is formed in an upper wall portion constituting the receptacle 13. The unreleasable lock portion 17 is arranged to the left of the deflection restricting portion 14 and arranged in an opening end part of the upper wall portion. A lock receiving surface 18 of the unreleasable lock portion 17 is not facing an opening side of the receptacle 13 and is facing the terminal holding portion 12 in the front-rear direction.

The second connector 20 includes a second housing 21 and a plurality of second terminal fittings 22. The second housing 21 is configured by uniting a detachable housing 23 made of synthetic resin and an inseparable housing 30 made of synthetic resin, which is a component separate from the detachable housing 23. A uniting direction of the detachable housing 23 and the inseparable housing 30 is a direction parallel to a connecting direction of the second housing 21 to the first housing 11. The second terminal fittings 22 are accommodated in the detachable housing 23 and the inseparable housing 30.

As shown in FIG. 3, the detachable housing 23 has a rectangular parallelepiped shape long in the lateral direction as a whole. The detachable housing 23 is fit into a space to the right of the deflecting restricting portion 14, out of the receptacle 13. A releasable lock piece 24 is formed on the lower surface of the detachable housing 23. The releasable lock piece 24 has a release operating portion (not shown) to be operated in an unlocking direction from behind the detachable housing 23. With the detachable housing 23 connected to the first housing 11, the releasable lock piece 24 is locked to the releasable lock portion 16, whereby the detachable housing 23 is locked in a state connected to the first housing 11. If the release operating portion is operated, the releasable lock piece 24 is disengaged from the releasable lock portion 16 and the detachable housing 23 can be separated from the first housing 11.

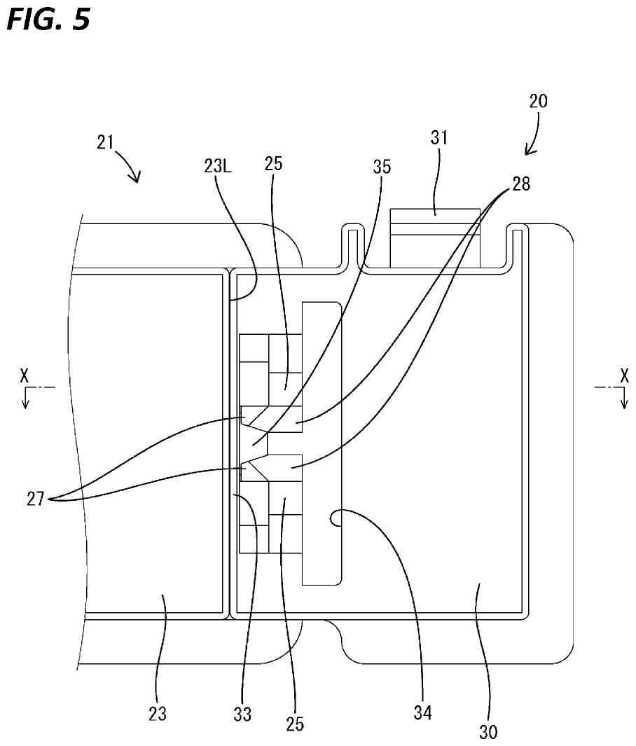

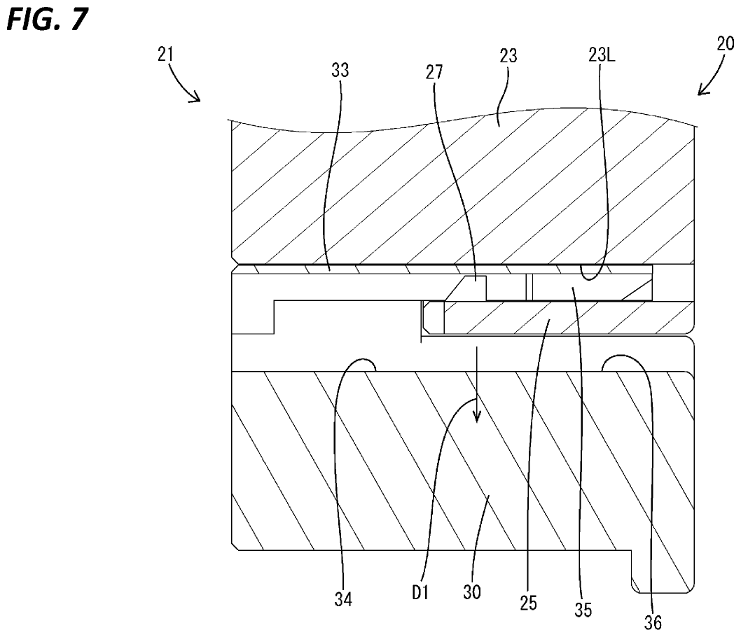

As shown in FIG. 3, a pair of vertically symmetrical resilient locking pieces 25 are formed in a left end part (right end part in FIGS. 3 and 5) of the detachable housing 23. A pair of supporting portions 26 are formed in both upper and lower end parts of a left outer side surface 23L of the detachable housing 23. Rear end parts of the resilient locking pieces 25 are connected to the supporting portions 26. The pair of upper and lower resilient locking pieces 25 can be resiliently displaced in a first deflecting direction D1 (see FIGS. 6 and 7) to move leftward away from the left outer side surface 23L with the supporting portions 26 as fulcrums. The first deflecting direction D1 is a direction orthogonal to both a connecting direction of the detachable housing 23 to the first housing 11 and the uniting direction of the detachable housing 23 with the inseparable housing 30. A first locking projection 27 projecting in a direction opposite to the first deflecting direction D1 is formed on a front end part (extending end part) of the resilient locking piece 25.

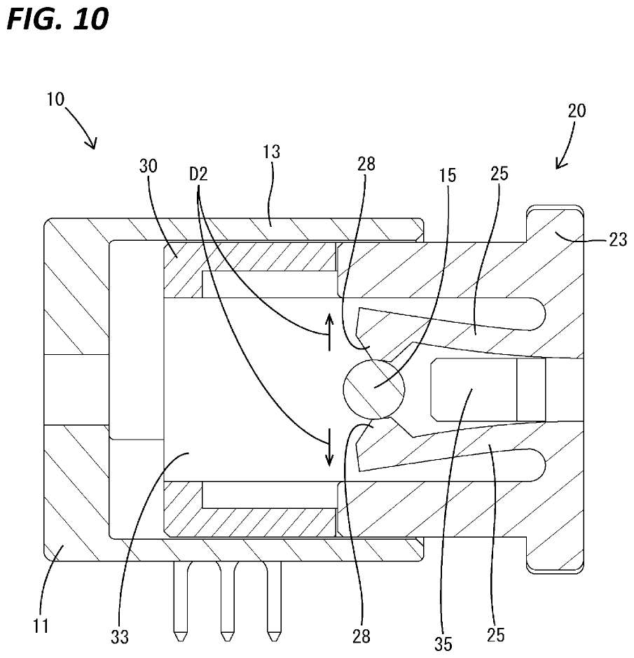

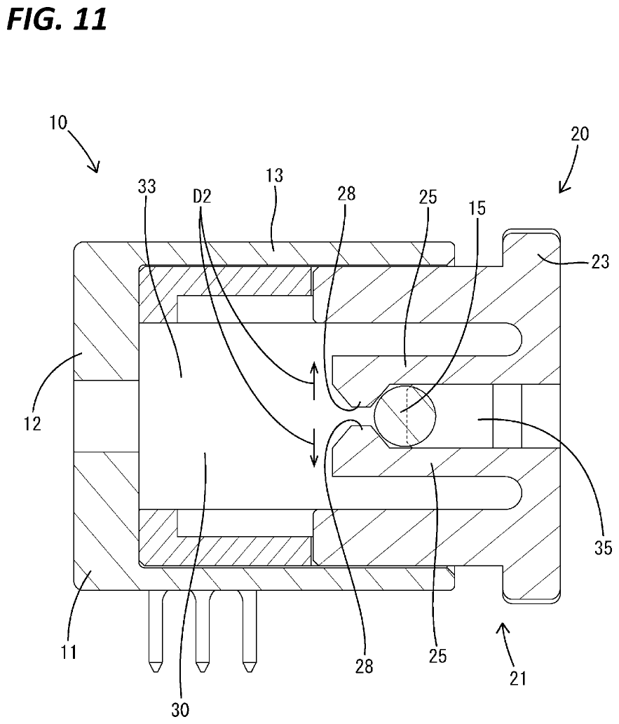

Each of the pair of upper and lower resilient locking pieces 25 can be resiliently displaced in a second deflecting direction D2 (see FIGS. 10 and 11) in parallel to the left outer side surface 23L of the detachable housing 23 and away from the mating resilient locking piece 25 with the supporting portion 26 as a fulcrum. The second deflecting direction D2 is a direction orthogonal to both the uniting direction of the detachable housing 23 with the inseparable housing 30 and the first deflecting direction D1. A second locking projection 28 projecting in a direction opposite to the second deflecting direction D2 is formed on the front end part of the resilient locking piece 25.

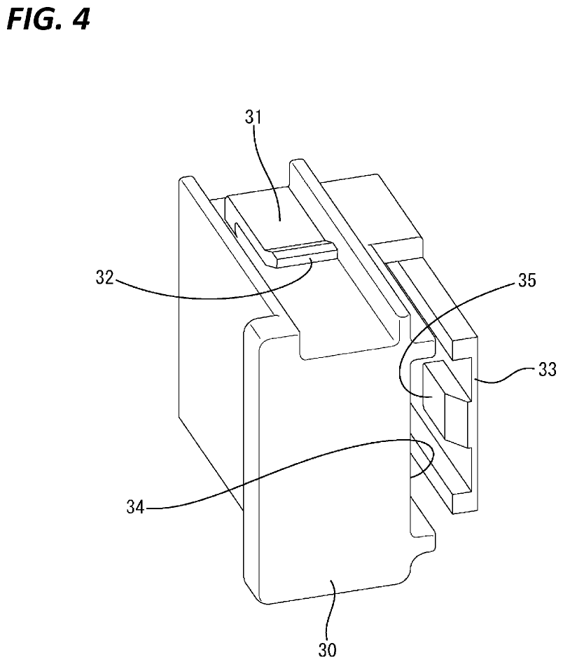

As shown in FIG. 4, the inseparable housing 30 has a rectangular parallelepiped shape having a smaller lateral dimension than the detachable housing 23. The inseparable housing 30 is fit into a space to the left of the deflecting restricting portion 14, out of the receptacle 13. A lock arm 31 is formed on the upper surface of the inseparable housing 30. The lock arm 31 is cantilevered rearward from the upper surface of the inseparable housing 30 and can be resiliently displaced in the vertical direction (direction orthogonal to a connecting direction of the inseparable housing 30 to the first housing 11). The rear end surface (extending end surface) of the lock arm 31 serves as an unreleasable lock surface 32.

A supporting wall portion 33 is formed in a right end part of the inseparable housing 30. A front end part of the supporting wall portion 33 is connected to the right outer side surface of the inseparable housing 30. A vertically long locking space 34 open in the rear surface of the inseparable housing 30 is formed between the right outer side surface (outer surface) of the inseparable housing 30 and the supporting wall portion 33. A projection-like lock receiving portion 35 is formed on the left side surface (surface facing the locking surface 34) of the supporting wall portion 33.

Circuits constituted by the first terminal fittings 19 and the second terminal fittings 22 are closed by connecting the first and second housings 11, 21. The circuit constituted by the second terminal fittings 22 accommodated in the detachable housing 23 can be switched to an open state if maintenance or the like is necessary. In contrast, the circuit constituted by the second terminal fittings 22 accommodated in the inseparable housing 30 is a critical circuit necessary for safe driving and the like of the automotive vehicle, wherefore this circuit is kept in the closed state without being switched to the open state once being closed.

In connecting the first and second housings 11, 21, the detachable housing 23 and the inseparable housing 30 are first united to configure the second housing 21. In setting the second housing 21 in the united state, the inseparable housing 30 is assembled with the detachable housing 23 by being brought closer from front. At this time, the supporting wall portion 33 in the right end part of the inseparable housing 30 is inserted between the left outer side surface 23L of the detachable housing 23 and the pair of resilient locking pieces 25.

In the process of assembling the detachable housing 23 and the inseparable housing 30, the first locking projections 27 interfere with the lock receiving portion 35 as shown in FIG. 6, whereby the resilient locking pieces 25 are resiliently displaced in the first deflecting direction D1. At this time, since a locking deflection space 36 is secured between the right outer side surface of the inseparable housing 30 and the resilient locking pieces 25, the resilient locking pieces 25 are displaced in the first deflecting direction D1 while entering the locking deflection space 36.

When the detachable housing 23 and the inseparable housing 30 reach a properly united state, the first locking projections 27 pass over the lock receiving portion 35 as shown in FIG. 7, whereby the resilient locking pieces 25 are resiliently restored and the first locking projections 27 face the lock receiving portion 35 from front. In this way, the detachable housing 23 is restricted from being relatively displaced rearward with respect to the inseparable housing 30. Further, a front end part of the supporting wall portion 33 and rear end parts of the supporting portions 26 are locked, whereby the detachable housing 23 is stopped in front with respect to the inseparable housing 30. In the above way, the detachable housing 23 and the inseparable housing 30 are laterally arranged and held in the united state, whereby the integrated second housing 21 is configured.

This integrated second housing 21 is fit into the receptacle 13 of the first housing 11. At this time, the detachable housing 23 is pushed toward the first housing 11. In the process of fitting the detachable housing 23, the second locking projections 28 interfere with the separation interfering portion 15 as shown in FIG. 10, whereby the resilient locking pieces 25 are resiliently displaced in the second deflecting direction D2. At this time, the resilient locking pieces 25 are temporarily disengaged from the lock receiving portion 35. However, since the inseparable housing 30 is pushed forward by the detachable housing 23, the inseparable housing 30 is fit into the receptacle 13 integrally with the detachable housing 23.

If the second housing 21 is fit to a proper connection position, the second locking projections 28 pass over the separation interfering portion 15 as shown in FIG. 11, whereby the resilient locking pieces 25 are resiliently restored, the second locking projections 28 are locked to the separation interfering portion 15, and the first locking projections 27 are locked to the lock receiving portion 35. The releasable lock piece 24 of the detachable housing 23 is locked to the releasable lock portion 16 of the first housing 11 and, by this locking, the detachable housing 23 is locked in the state connected to the first housing 11.

In the process of connecting the first and second housings 11, 21, the lock arm 31 of the inseparable housing 30 is resiliently displaced by interfering with the unreleasable lock portion 17 of the first housing 11. When the first and second housings 11, 21 reach a properly connected state, the lock arm 31 is resiliently restored and the unreleasable lock surface 32 proximately faces the lock receiving surface 18 in the front-rear direction. When an external force is applied to the inseparable housing 30 in a direction separating from the first housing 11, the unreleasable lock surface 32 butts against the lock receiving surface 18, thereby restricting the separation of the inseparable housing 30.

In separating the detachable housing 23 from a state where the first and second housings 11, 21 are connected, the releasable lock piece 24 is operated to be disengaged from the releasable lock portion 16, thereby releasing locking for the detachable housing 23. Subsequently, if the detachable housing 23 is pulled rearward with respect to the first housing 11 with this unlocked state kept, the second locking projections 28 interfere with the separation interfering portion 15 as shown in FIG. 10, whereby the resilient locking pieces 25 are resiliently displaced in the second deflecting direction D2.

If the resilient locking pieces 25 are resiliently displaced in the second deflecting direction D2, the first locking projections 27 are disengaged from the lock receiving portion 35 of the inseparable housing 30. Thus, the united state of the detachable housing 23 and the inseparable housing 30 is released. Therefore, the inseparable housing 30 is held in the state connected to the first housing 11 by the locking of the lock arm 31 and the unreleasable lock portion 17 and only the detachable housing 23 is separated from the first housing 11.

In connecting the detachable housing 23 separated from the first housing 11 to the first housing 11 again, the second locking projections 28 interfere with the separation interfering portion 15, whereby the resilient locking pieces 25 are resiliently displaced in the second deflecting direction D2. Accordingly, a connecting operation of the detachable housing 23 is not hindered due to the resilient locking pieces 25 caught on the separation interfering portion 15. Further, if the resilient locking pieces 25 are resiliently displaced in the second deflecting direction D2, the first locking projections 27 are retracted to such positions as not to interfere with the lock receiving portion 35. Thus, the first locking projections 27 are not caught on the lock receiving portion 35. In the above way, the detachable housing 23 can be connected to the first housing 11 with the inseparable housing 30 connected to the first housing 11.

The connector of this embodiment is provided with the first housing 11 and the second housing 21 connectable to the first housing 11. The second housing 21 includes the detachable housing 23 and the inseparable housing 30. The detachable housing 23 is both connectable to the first housing 11 and separable from the first housing 11.

In contrast, the inseparable housing 30 is connectable to the first housing 11, but is not separable from the first housing 11 once being connected to the first housing 11. As a means for restricting the separation of the inseparable housing 30, the first housing 11 is formed with the unreleasable lock portion 17 serving as a connecting lock portion and the inseparable housing 30 is formed with the lock arm 31 serving as a connecting lock portion. By locking the lock arm 31 to the unreleasable lock portion 17, the inseparable housing 30 and the detachable housing 23 are locked in the connected state. The lock arm 31 and the unreleasable lock portion 17 are formed not to have a part enabling the release of the locking by the lock arm 31 and the unreleasable lock portion 17. That is, the lock arm 31 and the unreleasable lock portion 17 have no unlock operating portion. The unlock operating portion is a part to be operated manually or by a jig from outside to unlock the lock arm 31 and the unreleasable lock portion 17.

Specifically, the unreleasable lock portion 17 is formed non-deformable. With the inseparable housing 30 connected to the first housing 11, the entire unreleasable lock surface 32 formed on the extending end surface of the lock arm 31 is hidden behind the unreleasable lock portion 17 of the first housing 11. Accordingly, even if a jig is inserted into between the receptacle 13 and the inseparable housing 30 from behind the inseparable housing 30, that jig cannot be caught on the unreleasable lock surface 32.

Further, with the inseparable housing 30 connected to the first housing 11, a lock deflection space 37 between the lock arm 31 and the upper wall portion of the receptacle 13 communicates with outside in the rear surface of the inseparable housing 30. However, a surface of the lock arm 31 facing the lock deflection space 37 is constituted only by a smooth inclined surface and has no irregularities for catching the jig or the like. Therefore, even if the jig is inserted into the lock deflection space 37 from behind the inseparable housing 30, that jig cannot be caught on the lock arm 31.

Note that the lock deflection space 37 is open in the outer surface of the terminal holding portion 12 of the first housing 11, but the first housing 11 is accommodated in a sealed device (not shown). Thus, the jig or the like cannot be inserted into the lock deflection space 37 from the outside of the terminal holding portion 12. Therefore, the locked state by the lock arm 31 and the unreleasable lock portion 17 cannot be released.

With the first and second housings 11, 21 connected, the inseparable housing 30 remains locked in the state connected to the first housing 11 when the detachable housing 23 is separated from the first housing 11. Therefore, out of the detachable housing 23 and the inseparable housing 30 in the connected state, only the detachable housing 23 can be separated from the first housing 11 according to the connector of this embodiment.

The detachable housing 23 includes the resilient locking pieces 25 serving as a uniting locking portion, and the inseparable housing 30 includes the lock receiving portion 35 serving as a uniting locking portion. The detachable housing 23 and the inseparable housing 30 are held in the united state by locking the resilient locking pieces 25 and the lock receiving portion 35 in a state not connected to the first housing 11 yet. According to this configuration, an operation of connecting the second housing 21 to the first housing 11 can be performed by one action.

The lock receiving portion 35 of the inseparable housing 30 is in the form of a projection. The resilient locking pieces 25 of the detachable housing 23 are resiliently displaceable in the first deflecting direction D1 intersecting an assembling direction of the detachable housing 23 with the inseparable housing 30. In the process of assembling the detachable housing 23 with the inseparable housing 30, the resilient locking pieces 25 are resiliently displaced in the first deflecting direction D1 by interfering with the lock receiving portion 35. With the detachable housing 23 assembled with the inseparable housing 30, the resiliently restored resilient locking pieces 25 are locked to the lock receiving portion 35. According to this configuration, workability is good since a separate manual operation of displacing the resilient locking pieces 25 is unnecessary in assembling the detachable housing 23 with the inseparable housing 30.

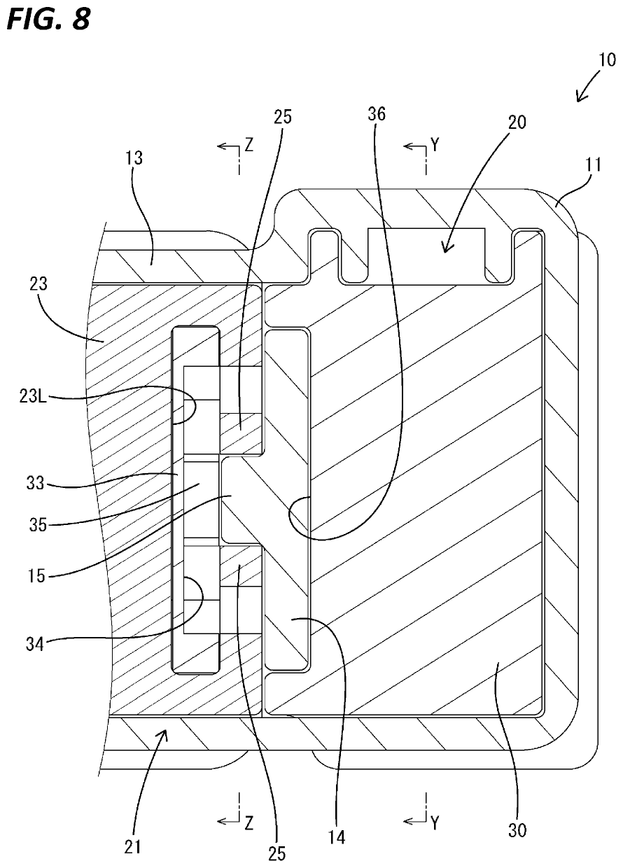

The first housing 11 includes the deflection restricting portion 14. With the detachable housing 23 connected to the first housing 11, the deflection restricting portion 14 is in the locking deflection space 36 as shown in FIG. 8. Thus, the resilient locking pieces 25 are restricted from being resiliently displaced in the first deflecting direction D1 by the deflection restricting portion 14. According to this configuration, even if the first and second housings 11, 21 in the connected state vibrate, there is no possibility that the first locking projections 27 are disengaged from the lock receiving portion 35, wherefore the resilient locking pieces 25 and the lock receiving portion 35 can be kept in the locked state.

The resilient locking pieces 25 can be resiliently displaced in the second deflecting direction D2. The second deflecting direction D2 is a direction intersecting both the assembling direction of the detachable housing 23 with the inseparable housing 30 and the first deflecting direction D1. The resilient locking pieces 25 are resiliently displaced in the second deflecting direction D2 when interfering with the separation interfering portion 15. According to this configuration, even if the resilient locking pieces 25 are restricted from being resiliently displaced in the first deflecting direction D1 by the deflection restricting portion 14, the resilient locking pieces 25 can be disengaged from the lock receiving portion 35 and the detachable housing 23 can be separated from the first housing 11 by resiliently displacing the resilient locking pieces 25 in the second deflecting direction D2.

The first housing 11 includes the separation interfering portion 15. In the process of separating the detachable housing 23 from the first housing 11, the resilient locking pieces 25 are disengaged from the lock receiving portion 35 by interfering with the separation interfering portion 15. According to this configuration, workability is good since a separate manual operation of disengaging the resilient locking pieces 25 from the lock receiving portion 35 is unnecessary in separating the detachable housing 23 from the first housing 11.

### Other Embodiments

The present invention is not limited to the above described and illustrated embodiment and is represented by claims. The present invention includes all changes in the scope of claims and in the meaning and scope of equivalents and is intended to include embodiments described below.

Although the detachable housing and the inseparable housing are connected to the first housing by one action by being united with each other in the above embodiment, the detachable housing and the inseparable housing may be separately connected to the first housing.

Although the connecting lock portion of the inseparable housing is the resiliently displaceable resilient lock piece in the above embodiment, the connecting lock portion of the first housing may be resiliently displaceable.

Although the uniting locking portions are unlocked in the process of separating the detachable housing from the first housing in the above embodiment, the uniting locking portions may be unlocked by a manual operation before the detachable housing is separated from the first housing.

Although the first housing is provided with the deflection restricting portion for restricting resilient displacements of the resilient locking pieces in the first deflecting direction in the above embodiment, the first housing may not include the deflection restricting portion.

Although the resilient locking pieces are resiliently displaced in the both first and second deflecting directions different from each other in the above embodiment, the resilient locking pieces may be resiliently deflectable only in either one of the deflecting directions.

Although the uniting locking portion of the detachable housing is the resiliently displaceable resilient locking pieces in the above embodiment, the uniting locking portion of the inseparable housing may be a resiliently displaceable resilient locking piece.

Although the first housing constitutes the board connector to be mounted on the circuit board in the above embodiment, the first housing may be mounted on an end part of a wiring harness.

### LIST OF REFERENCE NUMERALS

10 . . . first connector

11 . . . first housing

12 . . . terminal holding portion

13 . . . receptacle

14 . . . deflection restricting portion

15 . . . separation interfering portion

16 . . . releasable lock portion

17 . . . unreleasable lock portion

18 . . . lock receiving surface

19 . . . first terminal fitting

20 . . . second connector

21 . . . second housing

22 . . . second terminal fitting

23 . . . detachable housing

23L . . . left outer side surface of detachable housing

24 . . . releasable lock piece

25 . . . resilient locking piece

26 . . . supporting portion

27 . . . first locking projection

28 . . . second locking projection

30 . . . inseparable housing

31 . . . lock arm

32 . . . unreleasable lock surface

33 . . . supporting wall portion

34 . . . locking space

35 . . . lock receiving portion

36 . . . locking deflection space

47 . . . lock deflection space

D1 . . . first deflecting direction

D2 . . . second deflecting direction

1. A connector, comprising:
a first housing; and
a second housing connectable to the first housing,
wherein:
the second housing includes a detachable housing connectable to the first housing and separable from the first housing and an inseparable housing connectable to the first housing,
the first housing and the inseparable housing are provided with connecting lock portions for locking the inseparable housing and the first housing in a connected state, and
the connecting lock portions have no part enabling release of locking by the connecting lock portions.

2. The connector of claim 1, wherein:
the detachable housing and the inseparable housing include uniting locking portions, and
the detachable housing and the inseparable housing are held in a united state by locking the uniting locking portions to each other in a state not connected to the first housing yet.

3. The connector of claim 2, wherein:
the uniting locking portion of the inseparable housing is a projection-like lock receiving portion,
the uniting locking portion of the detachable housing is a resilient locking piece resiliently displaceable in a first deflecting direction intersecting an assembling direction of the detachable housing with the inseparable housing,
the resilient locking piece is resiliently displaced in the first deflecting direction by interfering with the lock receiving portion in the process of assembling the detachable housing with the inseparable housing, and
the resiliently restored resilient locking piece is locked to the lock receiving portion with the detachable housing assembled with the inseparable housing.

4. The connector of claim 3, wherein:
the first housing includes a deflection restricting portion, and
the resilient locking piece is restricted from being resiliently displaced in the first deflecting direction by the deflection restricting portion with the detachable housing connected to the first housing.

5. The connector of claim 3, wherein:
the first housing includes a separation interfering portion, and
the resilient locking piece is disengaged from the lock receiving portion by interfering with the separation interfering portion in the process of separating the detachable housing from the first housing.

6. The connector of claim 5, wherein:
the first housing includes a deflection restricting portion,
the resilient locking piece is restricted from being resiliently displaced in the first deflecting direction by the deflection restricting portion with the detachable housing connected to the first housing,
the resilient locking piece is resiliently displaceable in a second deflecting direction intersecting both the assembling direction of the detachable housing with the inseparable housing and the first deflecting direction, and
the resilient locking piece is resiliently displaced in the second deflecting direction when interfering with the separation interfering portion.
